(19) United States
(12) Patent Application Publication
(10) Pub. No.: US 2022/0152532 A1
(43) Pub. Date: May 19, 2022

(54) Vacuum device having a sintered metal bag filter

(71) Applicant: Diener electronic GmbH & Co. KG, Ebhausen (DE)

(72) Inventor: Christof-Herbert DIENER, Nagold (DE)

(21) Appl. No.: 17/454,928

(22) Filed: Nov. 15, 2021

(30) Foreign Application Priority Data
Nov. 17, 2020 (DE) 102020214439.7

(51) Int. Cl. B01D 29/23; B01D 39/10; H05H 1/46

(52) U.S. Cl. CPC B01D 29/232; B01D 39/10; H05H 1/46; B01D 2258/02; B01D 2265/04; B01D 2239/10; B01D 2239/1241

(57) ABSTRACT

The invention relates to a vacuum device having a vacuum chamber and to a vacuum pump for evacuating the vacuum chamber. The vacuum device can have a plasma generator in order to be able to treat items to be treated in the vacuum chamber with a plasma. An exhaust gas particle filter is connected upstream of the vacuum pump in order to protect the vacuum pump from aggressive reagents from the vacuum chamber. The exhaust gas particle filter has a filter element having a plurality of sintered metal filter bags. The sintered metal filter bags are preferably each formed from two tapered sintered sheet metal strips. The filter element can be connected to the plasma generator as an electrode of the plasma generator. The invention further relates to the use of an exhaust gas particle filter having sintered metal filter bags for protecting a vacuum pump.

### BACKGROUND OF THE INVENTION

The invention relates to a vacuum device according to the preamble of claim 1. The invention further relates to a use of an exhaust gas particle filter according to the preamble of claim 12.

In vacuum chambers—with or without a plasma source—a vacuum pump can generate a negative pressure. Such vacuum chambers are known from the inventor's book “Handbook of Plasma Surface Technology” under ISBN 978-3-9822206-0-4. It is also known to protect vacuum pumps from sucked in substances, in particular gases and particles. For example, it has become known from DE 10 2014 016 380 A1 to feed extracted gases to a plasma source in order to protect a vacuum pump.

However, the known devices for protecting vacuum pumps are often structurally complex and/or can only be cleaned with great difficulty.

### OBJECT OF THE INVENTION

It is therefore the object of the invention to provide a structurally simple but effective protection for a vacuum pump.

### DESCRIPTION OF THE INVENTION

This object is achieved according to the invention by a vacuum device according to claim 1 and by a method according to claim 12. The dependent claims reflect preferred developments.

The object of the invention is thus achieved by a vacuum device having a vacuum chamber for treating items to be treated, by a vacuum pump, and by an exhaust gas particle filter connected upstream of the vacuum pump, the exhaust gas particle filter comprising a filter element having a plurality of sintered metal filter bags.

Such filter bags have connected surfaces having sintered metal. The sintered metal filter bags are inexpensive to manufacture and yet very resistant, so that they can be cleaned at high temperatures and/or using aggressive chemical substances. In addition, sintered metal filter bags hold back the smallest particles very efficiently. For example, organosilicon impurities (e.g. SiOx) can be removed using caustic soda. Without removing the filter element, it can also be cleaned of organosilicon compounds using fluorine-containing plasma.

The sintered metal filter bags preferably consist of two sintered sheet metal strips which are connected at the end, in particular welded or soldered.

The sheet metal strips are preferably each formed from a carrier provided with openings, sintered metal particles being introduced into the openings.

The carriers can have a skeleton made of metal, in particular made of expanded metal, in which the sintered metal particles are introduced. The skeleton can have a plurality of webs. The skeleton can be designed in the form of a wire mesh, the openings or pores of which are filled with sintered metal particles. The skeleton gives the sheet metal strips the necessary stability. The sheet metal strips can be made correspondingly thin so that a large volume flow can be conducted through the filter element.

The sintered metal bag filters can have a skeleton made of expanded metal and/or wire mesh. The sintered metal bag filters can be thin-walled. They preferably have a wall thickness of less than 1.5 mm, in particular less than 1 mm, particularly preferably less than 0.5 mm.

The two sheet metal strips can be of similar, in particular the same, design. The sintered metal filter bags are particularly preferably V-shaped.

A very robust and structurally simple configuration is achieved if the filter element is designed in the form of a radially permeable round filter element having sintered metal filter bags arranged in a star shape in cross section. The sintered metal filter bags can be held axially at least at one end, in particular at both ends, by an end plate of the filter element.

The sintered metal filter bags can be designed to hold back particles with a size of less than 1.5 μm, in particular less than 1 μm, preferably less than 0.5 μm. In this way, very effective protection of the vacuum pump can be achieved.

In a further preferred embodiment of the invention, the filter element, in particular without a filter housing, is arranged in a space-saving manner in the interior of the vacuum chamber.

The vacuum device can have a plasma generator. The plasma generator can be electrically connected to the filter element so that the filter element can be used as an electrode of the plasma generator.

A plasma generator can be provided for generating a plasma in the vacuum chamber for plasma treating the items to be treated. The plasma generator can be the plasma generator electrically connected to the filter element or another plasma generator.

An electrode of the plasma generator, in particular lance-shaped, can be designed for introduction into a container to be treated. The vacuum device is preferably designed for treating, in particular plasma treating, a container in the form of a bottle and/or for treating a container in the form of a cup.

The electrode can have a through opening so that it can be used as a media feed or media discharge through the electrode.

The vacuum device can have a heating source for heating the filter element. This allows regular regeneration of the filter element in a simple manner.

To remove filtered residues, the vacuum device can have a ventilation valve which is arranged between the exhaust gas particle filter and the vacuum pump. The ventilation valve ensures that unwanted residue is returned to the vacuum chamber. There it can then be easily removed with a vacuum cleaner. This is particularly advantageous in powder treatment systems.

The invention further relates to the use of an exhaust gas particle filter in a vacuum device, wherein the exhaust gas particle filter comprises a filter element having a plurality of sintered metal filter bags and the exhaust gas particle filter is arranged between a vacuum chamber and a vacuum pump. The vacuum device can be designed as described above.

Further advantages of the invention can be found in the descriptions and the drawings. Likewise, according to the invention, the aforementioned features and those which are to be explained below can each be used individually for themselves or for a plurality of combinations of any kind. The embodiments shown and described are not to be understood as an exhaustive enumeration but rather have exemplary character for the description of the invention.

### DETAILED DESCRIPTIONS OF THE INVENTION AND DRAWINGS

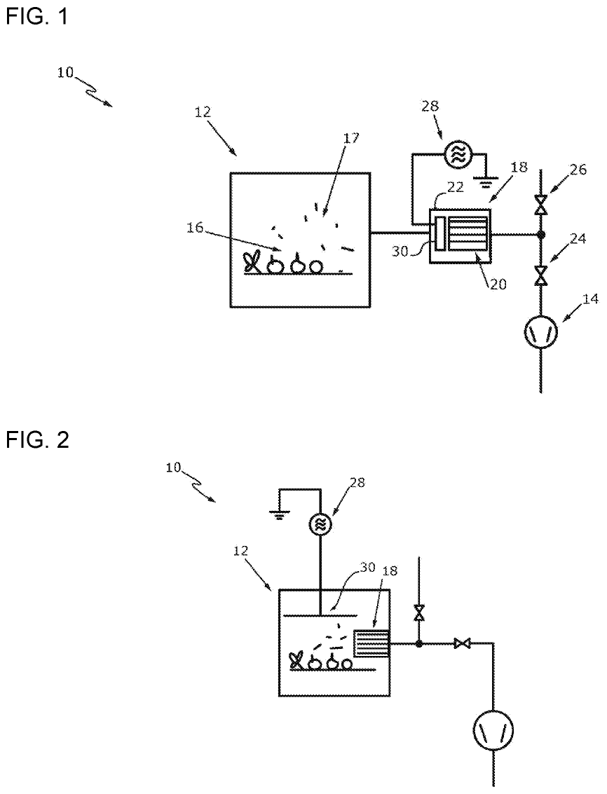

FIG. 1 is a schematic view of a first embodiment of a vacuum device according to the invention with an exhaust gas particle filter arranged upstream of a vacuum pump.

FIG. 2 is a schematic view of a second embodiment of a vacuum device according to the invention with a filter element arranged in a vacuum chamber.

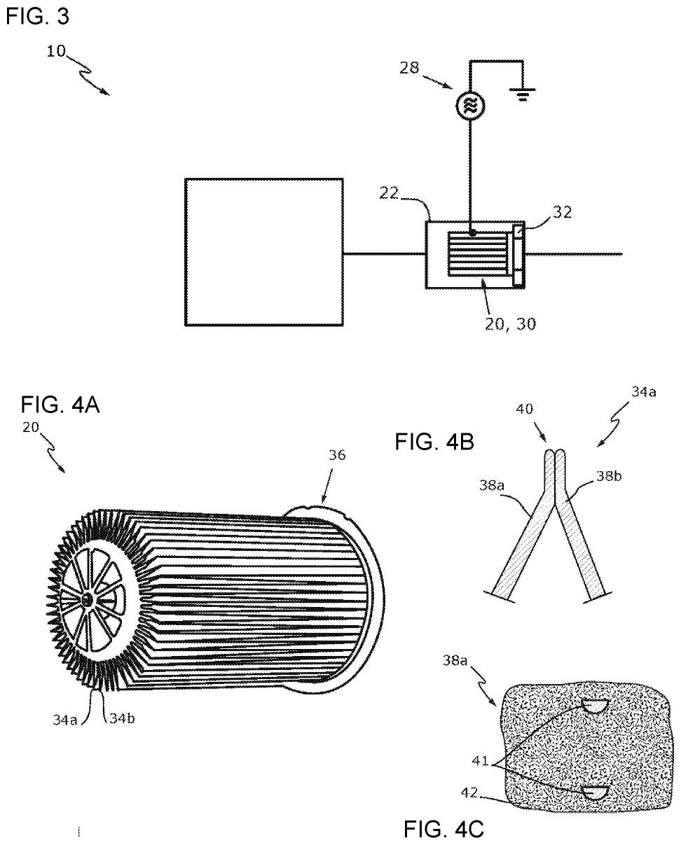

FIG. 3 is a schematic view of part of a vacuum device according to the invention with a filter element on which a plasma can be ignited.

FIG. 4a is an isometric view of a filter element used according to the invention.

FIG. 4b is a sectional view of part of the filter element from FIG. 4a.

FIG. 4c is a sectional view of part of the filter element from FIG. 4b.

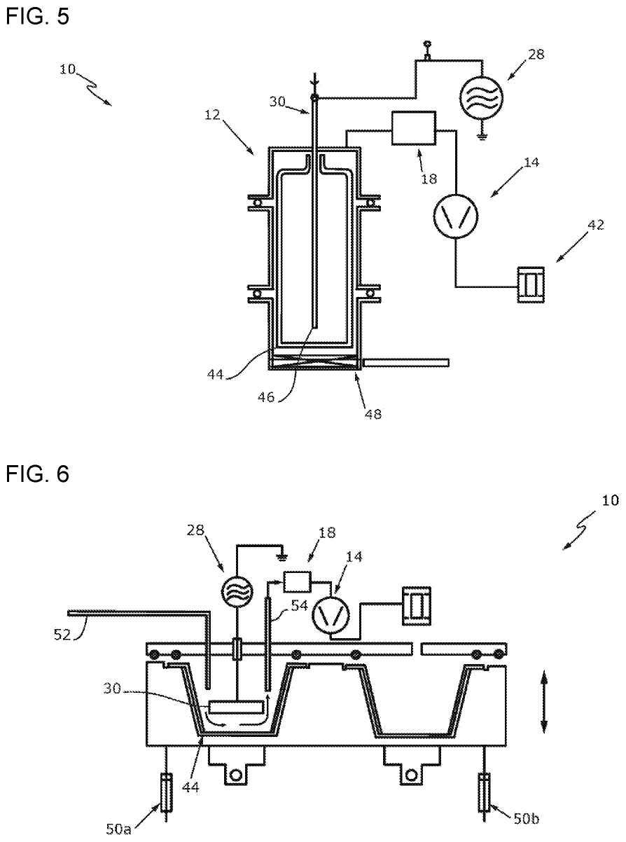

FIG. 5 is a schematic view of a vacuum device according to the invention for plasma treating the interior of a bottle-shaped container.

FIG. 6 is a schematic view of a further vacuum device according to the invention for plasma treating the interior of a cup-shaped container.

FIG. 1 shows a vacuum device 10 having a vacuum chamber 12 and a vacuum pump 14. Items to be treated 16 can be treated, in particular dried, in the vacuum chamber 12. While treating the items to be treated 16, undesired substances are also generated or undesired substances remain in the vacuum chamber 12. These substances can in particular be in the form of particles 17. According to the invention, an exhaust gas particle filter 18 is therefore arranged between the vacuum chamber 12 and the vacuum pump 14. The exhaust gas particle filter 18 serves for the protection of the vacuum pump 14 from substances extracted out of the vacuum chamber 12. The exhaust gas particle filter 18 has a filter element 20 and a filter housing 22. The filter element 20 is preferably arranged exchangeably in the filter housing 22.

A pump valve 24 can be connected upstream of the vacuum pump 14. As an alternative or in addition to this, a ventilation valve 26 can be arranged between the exhaust gas particle filter 18 and the vacuum pump 14. Undesired substances can be eliminated upstream of the vacuum pump 14 via the ventilation valve 26.

The vacuum device 10 can have a plasma generator 28. The plasma generator 28 can be connected to an electrode 30 in the interior of the filter housing 22, so that a plasma can be ignited in the interior of the filter housing 22. The plasma can be ignited before, during, and/or after the vacuum treatment of the items to be treated 16. The plasma can protect the vacuum pump 14 from undesired substances and/or can be used to clean the filter element 20.

FIG. 2 shows a further vacuum device 10. The vacuum device 10 has a plasma generator 28 which, in particular by means of an electrode 30, is designed to ignite a plasma in a vacuum chamber 12. It can be seen from FIG. 2 that an exhaust gas particle filter 18 is arranged in the interior of the vacuum chamber 12.

FIG. 3 shows part of a further vacuum device 10 in which a filter element 20 serves as an electrode 30 of a plasma generator 28. An insulator 32 can be provided in the interior of a filter housing 22 in order to isolate the filter element 20 from the filter housing 22.

FIG. 4a shows a filter element 20. From FIG. 4a, it can be seen that the filter element 20 is designed in the form of a round filter element. It has a plurality of sintered metal filter bags which are arranged in a star shape and are preferably of the same design, of which, for reasons of clarity, only the sintered metal filter bags 34a, 34b are provided with a reference sign. The sintered metal filter bags 34a, b are axially held at least at one end by an end plate 36. In the present case, the filter element 20 can be subjected to a radial flow, the gas flow emerging axially from the filter element 20.

FIG. 4b shows part of a cross section of the sintered metal filter bag 34a from FIG. 4a. FIG. 4b shows that the sintered metal filter bag 34a has two sintered sheet metal strips 38a, 38b. The sintered sheet metal strips 38a, b have a V-shape in the cross section of the filter element 20 (see FIG. 4a). The sheet metal strips 38a, b are preferably connected in the region of their end face 40, in particular welded or soldered together. The two sheet metal strips 38a, b can be turned over in the region of the end face 40 (not shown). The sheet metal strips 38a, b can be produced from a carrier with a plurality of openings, sintered metal particles being introduced into the openings. This is explained in more detail in FIG. 4c.

FIG. 4c shows a microscopic sectional view of the sintered sheet metal strip 38a from FIG. 4b. From FIG. 4c, it can be seen that the sintered sheet metal strip 38a has a carrier or a skeleton 41, in particular made of expanded metal, sintered metal particles 42 being arranged between the webs of the skeleton 41.

FIG. 5 shows a further vacuum device 10 having a vacuum chamber 12, a vacuum pump 14, and an exhaust gas particle filter 18. The vacuum pump 14 is followed by a filter 43, in this case in the form of an activated carbon filter.

The vacuum device 10 is designed for plasma treating the interior of a container 44, in this case in the form of a bottle-shaped container. For this purpose, a plasma generator 28 is connected to a lance-shaped electrode 30 which can be introduced into the container 44. In addition, the electrode 30 can preferably have at least one through opening 46 for introducing process gas. The vacuum chamber 12 can be ventilated through a chamber valve 48, in this case in the form of a slide valve.

FIG. 6 shows a further vacuum device 10 for treating a container 44, in this case in the form of a cup, for example a jam cup. The vacuum device 10 has cylinders 50a, 50b for rapid loading and unloading of the container 44. A media feed 52 is provided for coating the container 44. In particular, hexamethyldisiloxane (HMDSO), hexamethyldisilazane (HMDSN), ethyne (acetylene) and/or oxygen (O₂) can be fed in via the media feed 52. A plasma generator 28 and an electrode 30 are provided for plasma treating, in particular plasma coating. A media discharge 54 opens into an exhaust gas particle filter 18, which is fluidly arranged upstream of a vacuum pump 14.

Taking all the figures of the drawings together, the invention relates to a vacuum device 10 having a vacuum chamber 12 and to a vacuum pump 14 for evacuating the vacuum chamber 12. The vacuum device 10 can have a plasma generator 28 in order to be able to treat items to be treated 16 in the vacuum chamber 12 with a plasma. An exhaust gas particle filter 18 is connected upstream of the vacuum pump 14 in order to protect the vacuum pump 14 from aggressive reagents from the vacuum chamber 12. The exhaust gas particle filter 18 has a filter element 20 with a plurality of sintered metal filter bags 34a, b. The sintered metal filter bags 34a, b are preferably each formed from two tapered sintered sheet metal strips 38a, b. The filter element 20 can be connected to the plasma generator 28 as an electrode 30 of the plasma generator 28. The invention further relates to the use of an exhaust gas particle filter 18 with sintered metal filter bags 34a, b for protecting a vacuum pump 14.

### LIST OF REFERENCE SIGNS

10 Vacuum device
12 Vacuum chamber
14 Vacuum pump
16 Items to be treated
17 Particles
18 Exhaust gas particle filter
20 Filter element
22 Filter housing
24 Pump valve
26 Ventilation valve
28 Plasma generator
30 Electrode
32 Insulator
34a, b Sintered metal filter bag
36 End plate
38a, b Sintered sheet metal strip
40 Front side
41 Skeleton
42 Sintered metal particles
43 Filter
44 Container
46 Through opening
48 Chamber valve
50a, b Cylinder
52 Media feed
54 Media discharge

1. A vacuum device (10), wherein the vacuum device (10) comprises:
a) a vacuum chamber (12) for treating items to be treated (16);
b) a vacuum pump (14) fluidly connected to the vacuum chamber (12) for generating a negative pressure in the vacuum chamber (12);
characterized in that the vacuum device (10) comprises:
c) an exhaust gas particle filter (18) fluidly connected upstream of the vacuum pump (14) and having a filter element (20), wherein the filter element (20) has a plurality of sintered metal filter bags (34a, b).

2. The vacuum device according to claim 1, in which the sintered metal filter bags (34a, b) each consist of two sintered sheet metal strips (38a, b) which are connected, in particular welded or soldered, in the region of their end face (40).

3. The vacuum device according to claim 1, in which the filter element (20) is designed in the form of a radially permeable round filter element having sintered metal filter bags (34a, b) arranged in a star shape in cross section.

4. The vacuum device according to claim 1, in which the sintered metal filter bags (34a, b) are designed to hold back particles (17) with a size of less than 1500 nm, in particular with a size of less than 1000 nm, preferably with a size of less than 500 nm.

5. The vacuum device according to claim 1, in which the filter element (20) is arranged in the interior of the vacuum chamber (12).

6. The vacuum device according to claim 1, in which the vacuum device (10) has a plasma generator (28), wherein an electrically conductive part of the filter element (20) is electrically connected to the plasma generator (28) so that the filter element (20) can be used as an electrode (30) of the plasma generator (28).

7. The vacuum device according to claim 1, in which the vacuum device (10) has a plasma generator (28) for igniting a plasma in the vacuum chamber (12).

8. The vacuum device according to claim 6, in which one electrode (30) of the plasma generator (28) is designed for introduction into a container (44) to be treated.

9. The vacuum device according to claim 8, in which the electrode (30) has at least one through opening (46) for forming a media feed or media discharge through the electrode (30).

10. The vacuum device according to claim 1, in which the vacuum device (10) has a heating source for regenerating the filter element (20) in the region of the filter element (20).

11. The vacuum device according to claim 1, in which the vacuum device (10) has a ventilation valve (26) which is arranged fluidly between the exhaust gas particle filter (18) and the vacuum pump (14).

12. An exhaust gas particle filter (18) for use in a vacuum device (10), wherein the exhaust gas particle filter (18) comprises a filter element (20) having a plurality of sintered metal filter bags (34a, b), characterized in that the exhaust gas particle filter (18) is fluidly arranged between a vacuum chamber (12) and a vacuum pump (14).
